(19) United States
(12) Patent Application Publication
(10) Pub. No.: US 2010/0068993 A1
(43) Pub. Date: Mar. 18, 2010

(54) SYSTEM AND METHOD FOR SATELLITE-LONG TERM EVOLUTION (S-LTE) AIR INTERFACE

(76) Inventor: Rahil Khan, Frisco, TX (US)

Correspondence Address: ERICSSON INC., 6300 LEGACY DRIVE, M/S EVR 1-C-11, PLANO, TX, 75024, US

(21) Appl. No.: 12/209,436

(22) Filed: Sep. 12, 2008

(51) Int. Cl. H04B 7/185

(52) U.S. Cl. 455/12.1

(57) ABSTRACT

An air interface for use with a mobile satellite system that extends the baseline LTE interface modulation and coding from 3GPP. The LTE OFDM and S-FDMA technologies are used in the lowest FDD E-UTRA assigned bandwidth of 1.4 MHz but can be extended up to 7 other bands. The key differentiator for S-LTE from LTE would be the use of 32-ary Amplitude Phase Shift Keying (32-APSK) in the uplink channel for S-FDMA with LDPC and turbo coding and 64-QAM in the downlink channel for OFDM with LDPC and turbo coding. This new mechanism for S-LTE with new combination of coding will allow a robust channel model for S-LTE air interface and will enable the S-LTE air interface to have an efficient link budget. The S-LTE air interface of the present invention can be implemented in 700 MHz, 1.5 GHz, 2.1 GHz and 2.6 GHz bands or any future bands allocated for the specific air interface.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

The present invention relates to wireless communication systems. The Long Term Evolution (LTE) standard, which specifies the route from Third Generation (3G) data and communications systems to Fourth Generation (4G) data and communications systems establishes a new air interface using certain modulation and coding schemes. LTE uses Orthogonal Frequency Division Multiplexing (OFDM) in the downlink and Single carrier Frequency Division Multiple Access (S-FDMA) in uplink. The Mobile Satellite System (MSS) is a variant of an air interface for Global System for Mobile communication (GSM), General Packet Radio System (GPRS), Enhanced GPRS (EGPRS) and Universal Mobile Telecommunication System (UMTS).

Currently there are no standards for high-speed broadband mobile satellite system technology as conventional technologies only provide high speed mobile communication for the terrestrial system. It would be advantageous to have a system and method that provides an air interface for use with the MSS having new and evolved concept for high-speed data. This would allow users to have broadband high-speed data and voice variant such VoIP over data in hard-to-reach areas. The present invention provides such a system and method.

### BRIEF SUMMARY OF THE INVENTION

The present invention includes a Satellite-LTE (S-LTE) air interface for use with MSS. The present invention, which facilitates broadband high-speed data in hard-to-reach areas, advances MSS and is a complementary part of the Ancillary Terrestrial Communication (ATC) for L-band or S-band allocated for MSS.

The present invention extends the baseline LTE interface modulation and coding from 3GPP for the satellite air interface. The present invention is meant to supersede the S-UMTS standard defined by ETSI. More specifically, the S-LTE of the present invention uses the LTE OFDM and S-FDMA technologies in the lowest FDD E-UTRA assigned bandwidth of 1.4 MHz but can be extended up to 7 other bands. The S-LTE air interface of the present invention can be implemented in 700 MHz, 1.5 GHz, 2.1 GHz and 2.6 GHz bands or any future bands allocated for the specific air interface.

As used herein, the following abbreviations shall have the following meanings:

3GPP 3^{rd} Generation Partnership Project

ATC Ancillary Terrestrial Communication

A-PSK Amplitude and Phase-Shift keying

CRC Cyclic Redundancy Check

CP Cyclic Prefix

DCI Downlink Channel Information

DVB-S2 Digital Video Broadcasting-Satellite 2

EGPRS Enhanced GPRS

eNode B Evolved Node B

ETSI European Telecommunications Standards Institute

E-UTRA Evolved Universal Terrestrial Radio Access

EVM Error Vector Magnitude

GSM Global System for Mobile communication

GPRS General Packet Radio System

HARQ Hybrid Automatic Repeat ReQuest

IMT2000 International Mobile Telecommunication 2000

LDPC Low-Density Parity-Check

LTE Long Term Evolution of 3G

MAC Medium Access Control

MBSFN Multicast/Broadcast Single Frequency Network

MIB Master Information Block

MIMO Multi Input Multi Output

MSS Mobile Satellite System

OFDM Orthogonal Frequency Division Multiplexing

QAM Quadrature Amplitude Modulation

QPSK Quadrature Phase Shift Keying

RAN Radio Access Node

S-FDMA Single carrier Frequency Division Multiple Access

SIB System Information Block

SIMO Single Input and Multi Output

S-BCH Satellite Broadcast Channel

S-LTE Satellite-LTE

S-RAN Satellite-Radio Access Network

S-UMTS Satellite-Universal Mobile Telecommunication System

UCI Uplink Channel Information

UE User Equipment

UMTS Universal Mobile Telecommunication System

UTRA Universal Terrestrial Radio Access

VoIP Voice over Internet Protocol

### BRIEF DESCRIPTION OF THE SEVERAL VIEWS OF THE DRAWING

In the following section, the invention will be described with reference to exemplary embodiments illustrated in the figures, in which:

FIG. 1 is the high-level network architecture of the present invention illustrating its connectivity to the terrestrial LTE;

FIG. 2 illustrates the physical channel of the S-LTE transport channel of the present invention;

FIG. 3 is an S-LTE OFDM time-frequency grid model with 12 sub-carriers of the present invention;

FIG. 4 is a diagram illustrating the radio bearer frequency definition for S-LTE of the present invention;

FIG. 5 is a diagram of the physical channel processing with coding and modulation for S-LTE of the present invention;

FIG. 6 is a diagram of the transport channel processing for modulation and coding transport blocks using S-UL-SCH of the present invention;

FIG. 7 is a diagram of multi-antenna mapping with up to four ports with spatial multiplexing and transmit diversity for S-LTE of the present invention; and

FIG. 8 is a diagram of the format of control signaling for downlink S-PDCCH of the present invention.

### DETAILED DESCRIPTION OF THE INVENTION

The present invention includes a Satellite-LTE (S-LTE) air interface for use with MSS. The present invention, which facilitates broadband high-speed data in hard-to-reach areas, advances MSS and is a complementary part of the Ancillary Terrestrial Communication (ATC) for L-band or S-band allocated for MSS.

The present invention extends the baseline LTE interface modulation and coding from 3GPP for use as the satellite air interface. The present invention is meant to supersede the S-UMTS standard defined by ETSI. More specifically, the S-LTE of the present invention uses the LTE OFDM and S-FDMA technologies in the lowest FDD E-UTRA assigned bandwidth of 1.4 MHz but can be extended up to 7 other bands. The S-LTE air interface of the present invention can be implemented in 700 MHz, 1.5 GHz, 2.1 GHz and 2.6 GHz bands or any future bands allocated for the specific air interface.

As more fully described herein, the present invention includes the following features and characteristics:

1. The present invention includes a mapping from LTE and DVB-S2;

2. The channel mapping to S-LTE is different from LTE;

3. The modulation coding scheme of the present invention is a combination of 64QAM from LTE and 32-APSK for channel robustness;

4. The present invention introduces a flag to facilitate mobility management between satellite and terrestrial systems. The flag value in S-LTE RAN and device/platform is retained for mobility management between S-LTE, LTE, WCDMA, GSM systems, as required, thus changing the idle mode behavior of the device/platform;

5. The power control of the present invention includes values for beam transmit power and total satellite transmit power. These values are added to the S-LTE RAN and are received by S-LTE device platform. Further parameters can be defined to refine the power control for satellite link budget for S-LTE and are implementation specific.

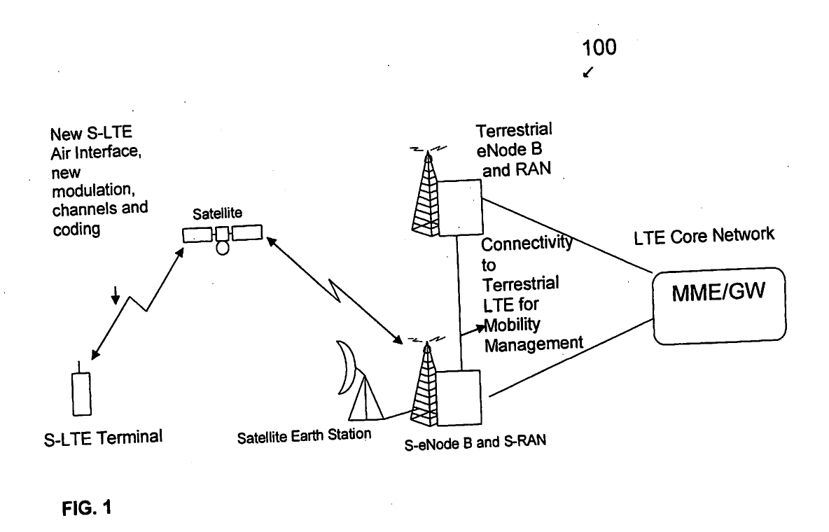

Referring now to FIG. 1, a high-level network architecture 100 of the S-LTE architecture of the present invention and its connectivity to terrestrial LTE is shown.

The S-LTE of the present invention utilize LTE OFDM and S-FDMA technologies. However, the S-FDMA will use a new 32-ary Amplitude Phase Shift Keying (32-APSK) instead of QPSK in the uplink channel (for robustness) with optimized turbo coding and LDPC in the lowest FDD E-UTRA assigned bandwidth of 1.4 MHz but can be extended to 7 other frequency bands. The downlink channel will still use the 64-QAM with OFDM as defined in LTE for S-LTE with optimized turbo coding and LDPC. An adaptive shift from 64-QAM to a 32-APSK can be performed based on the satellite channel conditions in the downlink channel. Similar techniques can be applied for the uplink channel where adaptive downgrade from 32-APSK to 16-APSK or QPSK can be utilized to close the link and maintain a feasible link budget. The scope of the adaptive coding scheme described further herein.

In the present invention, LTE source and channel coding, modulation, multiplexing, physical layer mapping are retained for the air interface. However, the present invention introduces new channels or re-definition of channels.

In the present invention, Layer 1 is defined in a bandwidth agnostic way based on resource blocks, allowing the LTE Layer 1 to adapt to various spectrum allocations. A resource block spans either 12 sub-carriers with a sub-carrier bandwidth of 15 kHz or 24 sub-carriers with a sub-carrier bandwidth of 7.5 kHz each over a slot duration of 0.5 ms. The S-LTE of the present invention uses the same standard resource block allocations.

The transport channels for S-LTE of the present invention are designated as follows:

S-LTE Downlink Transport Channels

Satellite-Broadcast Channel (S-BCH)

Satellite-Paging Channel (S-PCH)

Satellite-Downlink Shared Channel (S-DL-SCH)

Satellite-Multicast Channel (MCH)

S-LTE Uplink Transport Channels

Satellite-Uplink Shared Channel (S-UL-SCH)

Satellite-Random Access Channel (S-RACH)

The physical channels for S-LTE are as follows:

S-LTE Downlink Physical Channels

Satellite-Physical Broadcast Channel (S-PBCH)

Satellite-Physical Downlink Shared Channel (S-PDSCH)

Satellite-Physical Downlink Control Channel (S-PDCCH)

Satellite-Physical Control format Indicator Channel (S-PCFICH)

Satellite-Physical Hybrid ARQ Indicator Channel (S-PHICH)

Satellite-Physical Multicast Channel (S-PMCH)

Uplink Physical Channels

Satellite-Physical Uplink Shared Channel (S-PUSCH)

Satellite-Physical Uplink Control Channel (S-PUCCH)

Satellite-Physical Random Access Channel (S-PRACH)

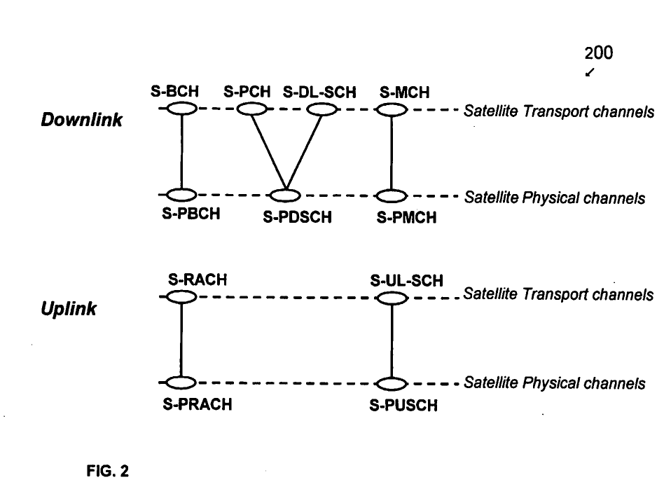

Referring now to FIG. 2, the S-LTE transport-channel to physical channel mapping 200 is shown below for both downlink and uplink respectively. All the other S-LTE channels will be used for Layer 1/Layer 2 control signaling.

Downlink Transmission Scheme for S-LTE

The downlink transmission scheme uses OFDM sub-carrier spacing as follows:

Δf=15 kHz [symbol] Tu≈66.7 μs

Cyclic prefix TCP≈4.7 μs/5.2 μs (With first symbol in each of the slot)

Extended cyclic prefix TCP-E≈16.7 μs

For MBSFN Transmission

For satellite spot-beams with very large time dispersion (spot-beams are equivalent to cells in LTE.

The Downlink Physical Resource for S-LTE

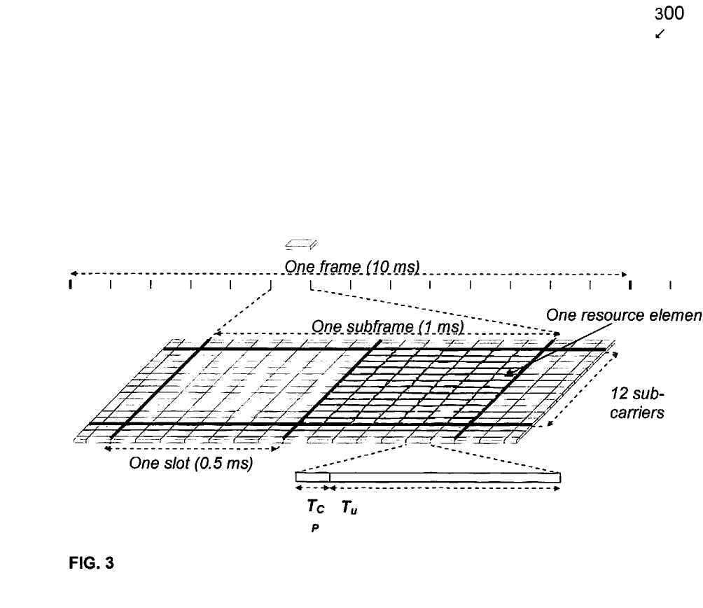

Referring now to FIG. 3, the downlink physical resource defined for S-LTE of the present invention is realized with the OFDM time-frequency grid model 300, having 12 sub-carriers. As seen therein, the time domain structure is as follows:

10 ms Frame consisting of 10 Sub-frames of length 1 ms

Each sub-frame consisting of 2 Slots of length 0.5 ms

Each slot consisting of 7 OFDM symbols (6 symbols in case of extended Cyclic-Prefix)

Resource blocks:

12 sub-carriers during one slot

Assigned in pairs of two consecutive resource blocks

Unused DC-carrier

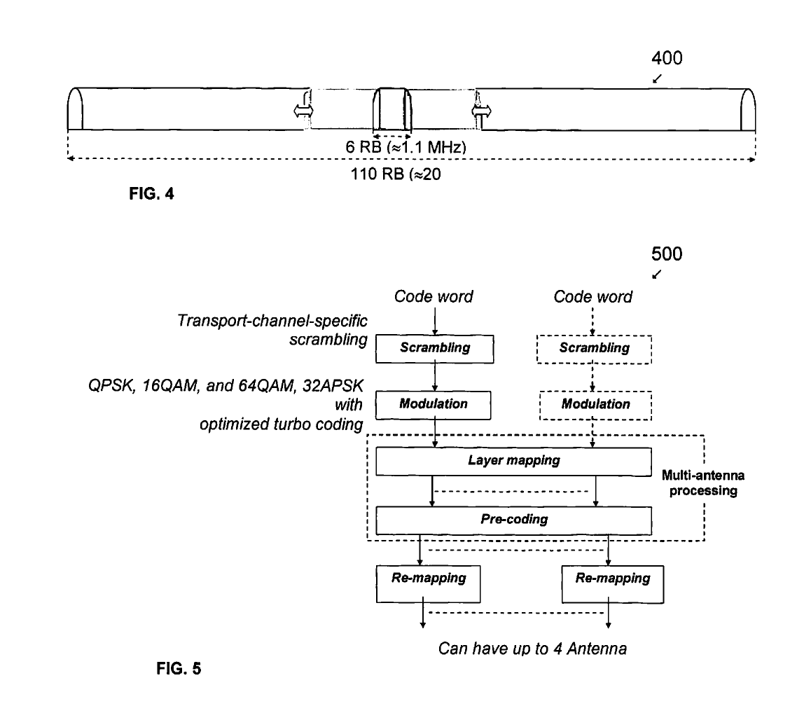

As seen in the diagram 400 of FIG. 4, the flexibility of the LTE physical layer specification facilitates the definition of any bandwidth for S-LTE of the present invention in the range of 6 Radio Bearers (RB) to 110 RB. Based on the limited set of bandwidth defined for S-LTE of the present invention, additional bandwidth can be defined for new frequencies in different carriers such as, but not limited to, L-Band, 700 MHz and 2600 MHz.

User Equipment (UE) shall support the S-LTE capability of the present invention.

Processing of Physical Channels in S-LTE

FIG. 5 is a diagram 500 of the physical channel processing with coding and modulation in accordance with the present invention. As seen therein, two additions have been introduced to improve performance for S-LTE:

32-APSK coding scheme similar to what is being used in DVB-S2; and

Optimized turbo coding with LDPC in the modulation.

Processing of Transport Channels in S-LTE

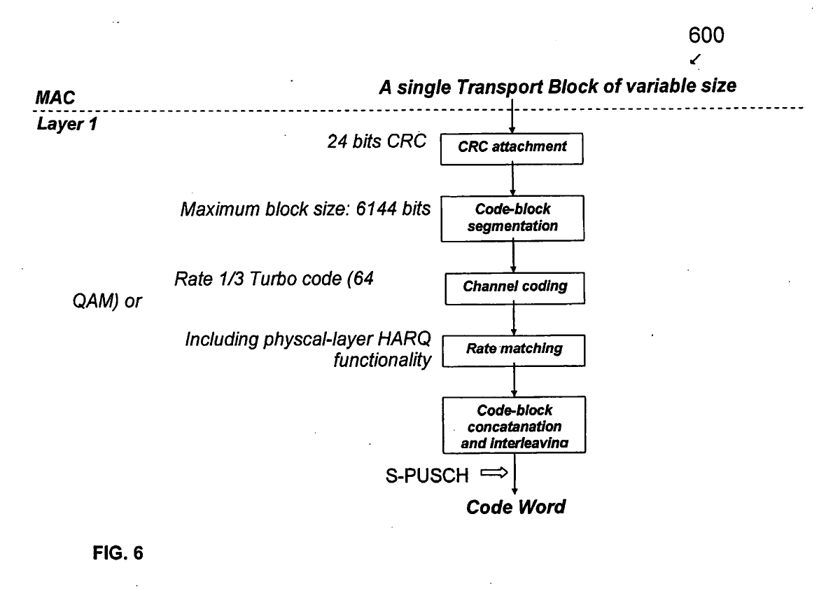

As seen in diagram 600 of FIG. 6, the transport channel processing is performed in Satellite-Uplink Shared Channel (S-UL-SCH) with a single transport block of variable size between Layer 1 and the MAC layer.

Antenna Transmission Approach

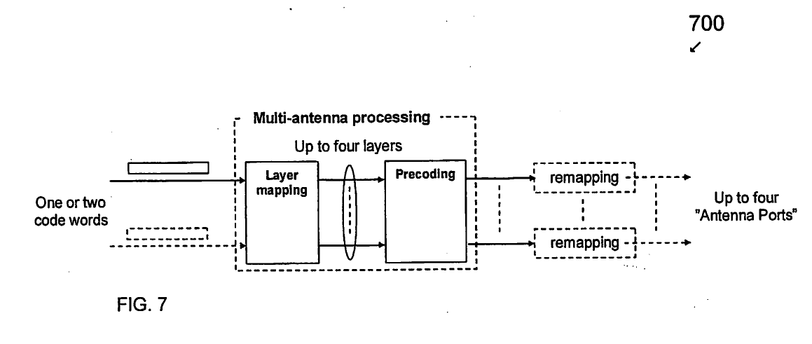

The multi antenna transmission approach of S-LTE of the present invention uses any of the one, two or four ports antenna transmit ports such as in MIMO. As seen in FIG. 7, multiple antenna ports will use multiple time-frequency grids to receive OFDM signals. Diagram 700 of FIG. 7 illustrates multi-antenna mapping with up to four ports with spatial multiplexing and transmit diversity for S-LTE.

Downlink spatial multiplexing is performed with two code words, mapping of up to four layers depending on the satellite channel rank, UE reports, coding and modulation type based on the link budget and type of MIMO antenna used. The modulation scheme and code rate can differ between the different layers, e.g., 64 QAM in two layers and 32-APSK in 2 layers with 1/3 and 4/5 code rates respectively. However, the same number of symbols are transmitted on each layer for symmetry.

In operation, the UE transmits the matrix with channel rank from a predefined code word book that is passed to the S-LTE radio network of the present invention. The S-LTE radio network will either follow the code word recommendations or will pick one from the code matrix defined in the radio access network. One layer can have beam forming transmit diversity whereas four layers can have frequency shift transmit diversity. The symbols are inserted in the downlink time-frequency grid for channel estimation. The S-LTE of the present invention uses modified-downlink coherent detection to cater to large satellite spot-beams.

Depending on number of transmit antennas, different methods will be used for transmitting downlink OFDM symbols in the S-LTE air interface slots. The OFDM symbols 0 to 4 will be used for each slot with 3 sub-carrier offset.

Downlink and Uplink Control Signaling Using Uplink and Downlink Control Information for S-LTE

To support downlink and uplink control signaling in the S-LTE of the present invention, the following S-LTE defined channels are used on the transport channel level:

Satellite-Downlink Shared Channel (S-DL-SCH)

Satellite-Uplink Shared Channel (S-UL-SCH)

The Control signaling at Layer 1 uses the following physical channels:

Satellite-Physical Downlink Control Channel (S-PDCCH)

Satellite-Physical Control format Indicator Channel (S-PCFICH)

Satellite-Physical Hybrid ARQ Indicator Channel (S-PHICH)

Downlink control signaling uses the following mechanism for control scheduling:

S-DL-SCH/S-PDSCH resource

S-DL-SCH transport format

HARQ-related information

Uplink Grant uses the following mechanism for scheduling:

S-UL-SCHPUSCH resource

S-UL-SCH transport format

HARQ-related information

The uplink control information (UCI) and downlink control information (DCI) are sent with channel coding, CRC attachment, rate matching, interleaving, scrambling and modulation. The Channel Quality Indicator information is sent for UCI with Channel Coding. This is required for SIMO and MIMO type antennas when used with a receiver including the UE and base station.

The DCI is sent on S-BCH with CRC, Channel Coding and rate matching. The UE must blindly find the control channel and their formats.

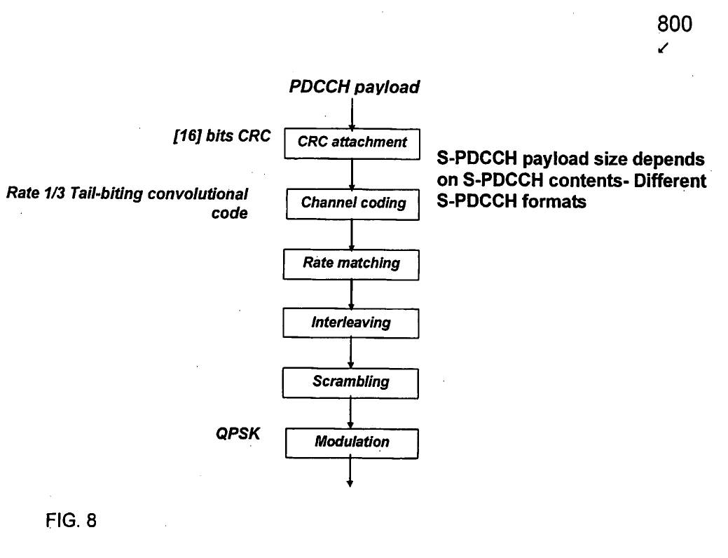

FIG. 8 is diagram 800 of the format of control signaling for the downlink S-PDCCH.

Spot Beam Search for S-LTE

The spot beam in an MSS is an equivalent entity to a cell, its size depending on the satellite footprint. The synchronization and spot beam search is based on finding a spot beam, timing and physical layer spot beam identity. The downlink reference signal of the identified spot beam contains timing, sequence, and frequency shift. Whereas LTE uses 510 different reference-signal sequences with 510 different cell identities, the S-LTE of the present invention uses 256 spot beam identities, although this can be updated based on the satellite and satellite base station and UE design. An orthogonal random sequence is applied to the spot beam search wherein each spot beam corresponds to a certain random sequence frequency shift.

In the present invention, two synchronization signals are transmitted every 5 milliseconds plus satellite delay of 240 milliseconds one way. The present invention uses primary and secondary synchronization signals with sub-frame 0 and 5 and OFDM symbol 6 and 5 respectively using six center resource blocks that constitutes 72 sub-carriers. This allows the receiver to read information contained in the S-BCH to enable the synchronization procedure of the S-LTE. Furthermore, a Frank-Zadoff-Chu sequence can be used for orthogonal spot beam search and synchronization.

Furthermore, the idle mode behavior of the S-LTE device/platform of the present invention can be enhanced to perform adaptive mobility management. This allows a complete mobility management and handover between the S-LTE of the present invention, terrestrial LTE, WCDMA, and GSM. Conventionally, MSS based devices, when in idle mode, perform manual search and handover. So the MSS and ATC network operates autonomously from the satellite network, and provides no mobility management support for active or idle users. The behavior can be changed to enhance the solution when introducing S-LTE by adding an early beam/cell configuration flag in the S-BCH. This flag is stored in an S-LTE device/platform of the present invention and is updated when the device/platform between an idle mode and a registered state.

System Information

In the present invention, system information is transmitted over the S-BCH and is divided into two parts. Static information is comprised of a Master Information Block (MIB) for S-LTE which has a transmission period of 40 milliseconds transmitted over the S-BCH, and dynamic information comprised of a System Information Block (SIB) which is part of a multiple scheduling with transmission period of 80, 160, and 320 milliseconds which is transmitted over S-DL-SCH.

Power Control in S-LTE

The minimum controlled output power of the UE is defined as the broadband transmit power of the UE, i.e. the power in the channel bandwidth similar to LTE in S-LTE for all transmit bandwidth configurations (resource blocks), when the power is set to a minimum value. The present invention includes two new values of beam transmit power and total satellite transmit power in the S-LTE RAN received by S-LTE device platform.

The power requirement for transmission based on the Error Vector Magnitude (EVM) is defined in terms of In phase and Quadrature phase (IQ). The IQ origin offset is the phase and amplitude of an additive sinusoidal waveform that has the same frequency as the reference waveform carrier frequency components. The minimum requirements on power control and emissions are adhered to for S-LTE.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed:

1. A mobile satellite system, comprising:
a User Equipment (UE);
a satellite; and
an air interface between the UE and satellite having a combination of Quadrature Amplitude Modulation (QAM) for its downlink channel and 32-ary Amplitude Phase-Shift keying (32-APSK) for its uplink channel.

2. The mobile satellite system of claim 1, wherein the downlink channels comprise downlink transport channels and downlink physical channels and the uplink channels comprise uplink transport channels and uplink physical channels.

3. The mobile satellite system of claim 2, wherein the downlink transport channels further comprise:
a Satellite-Broadcast Channel (S-BCH);
a Satellite-Paging Channel (S-PCH);
a Satellite-Downlink Shared Channel (S-DL-SCH);
a Satellite-Multicast Channel (MCH);
the downlink physical channels further comprise:
a Satellite-Physical Broadcast Channel (S-PBCH);
a Satellite-Physical Downlink Shared Channel (S-PDSCH);
a Satellite-Physical Downlink Control Channel (S-PDCCH);
a Satellite-Physical Control format Indicator Channel (S-PCFICH);
a Satellite-Physical Hybrid ARQ Indicator Channel (S-PHICH);
a Satellite-Physical Multicast Channel (S-PMCH);
the uplink transport channels further comprise:
a Satellite-Uplink Shared Channel (S-UL-SCH);
a Satellite-Random Access Channel (S-RACH);
the uplink physical channels further comprise:
a Satellite-Physical Uplink Shared Channel (S-PUSCH);
a Satellite-Physical Uplink Control Channel (S-PUCCH); and
a Satellite-Physical Random Access Channel (S-PRACH).

4. The mobile satellite system of claim 3, wherein the uplink transport channel processing is performed in the S-UL-SCH with a single transport block of variable size between Layer 1 and the MAC layer.

5. The mobile satellite system of claim 1, wherein the UE is adapted to communicate with an Ancillary Terrestrial Communication (ATC) system.

6. The mobile satellite system of claim 5, wherein a flag facilitates mobility management between the UE and the ATC system.

7. The mobile satellite system of claim 1, further comprising:
an evolved Node B (S-eNode B) base station transceiver in communication with the satellite; and
a radio access node (S-RAN) in communication with the S-eNode B.

8. The mobile satellite system of claim 7, wherein the S-RAN and UE control the beam transmit power and total transmit power of the satellite.

9. The mobile satellite system of claim 7, wherein the UE transmits a matrix with channel rank from a pre-defined code word book that is passed to the S-RAN.

10. The mobile satellite system of claim 9, wherein S-RAN determines to follow the code word recommendation of the UE or will chooses a code word from a code matrix defined in the S-RAN.

11. The mobile satellite system of claim 7, wherein:
downlink and uplink control signaling are on the transport channels S-DL-SCH and S-UL-SCH;
control signaling at Layer 1 are on the physical channels S-PDCCH, S-PCFICH, S-PHICH;
downlink control signaling use the following mechanisms for control scheduling: S-DL-SCH/S-PDSCH resource, S-DL-SCH transport format, HARQ-related information;
uplink grant uses the following mechanisms for scheduling: S-UL-SCHPUSCH resource, S-UL-SCH transport format, HARQ-related information.

12. The mobile satellite system of claim 11, wherein:
the uplink control information (UCI) and downlink control information (DCI) are sent with channel coding, CRC attachment, rate matching, interleaving, scrambling and modulation;
the Channel Quality Indicator information is sent for UCI with Channel Coding; and
the DCI is sent on S-BCH with CRC, Channel Coding and rate matching.

13. The mobile satellite system of claim 7, wherein: system information is transmitted over the S-BCH comprising a Master Information Block (MIB) having a transmission period of 40 milliseconds transmitted over the S-BCH, and dynamic information comprised of a System Information Block (SIB) which is part of a multiple scheduling with transmission period of 80, 160, and 320 milliseconds which is transmitted over S-DL-SCH.

14. The mobile satellite system of claim 1, wherein optimized turbo coding with Low-Density Parity-Check (LDPC) is used in the modulation.

15. The mobile satellite system of claim 1, wherein the system uses multiple antenna ports to process multiple time-frequency grids to receive OFDM signals.

16. The mobile satellite system of claim 1, wherein the UE performs a synchronization and spot beam search based on finding a spot beam of the satellite and timing and physical layer spot beam identity.

17. The mobile satellite system of claim 16, wherein the satellite uses 256 spot beam identities.

18. The mobile satellite system of claim 17, wherein the satellite transmits two synchronization signals every 5 milliseconds plus a satellite delay of 240 milliseconds one way.

19. A method of interfacing a User Equipment (UE) and a satellite, comprising the step of using a combination of Quadrature Amplitude Modulation (QAM) for downlink channel and 32-ary Amplitude Phase-Shift keying (32-APSK) for its uplink channel.

20. The method of claim 19, further comprising the step of setting up downlink transport channels:
a Satellite-Broadcast Channel (S-BCH);
a Satellite-Paging Channel (S-PCH);
a Satellite-Downlink Shared Channel (S-DL-SCH);
a Satellite-Multicast Channel (MCH);
downlink physical channels:
a Satellite-Physical Broadcast Channel (S-PBCH);
a Satellite-Physical Downlink Shared Channel (S-PDSCH);
a Satellite-Physical Downlink Control Channel (S-PDCCH);
a Satellite-Physical Control format Indicator Channel (S-PCFICH);
a Satellite-Physical Hybrid ARQ Indicator Channel (S-PHICH);
a Satellite-Physical Multicast Channel (S-PMCH);
uplink transport channels:
a Satellite-Uplink Shared Channel (S-UL-SCH);
a Satellite-Random Access Channel (S-RACH);
uplink physical channels further comprise:
a Satellite-Physical Uplink Shared Channel (S-PUSCH);
a Satellite-Physical Uplink Control Channel (S-PUCCH); and
a Satellite-Physical Random Access Channel (S-PRACH);
